(19) United States
(12) Patent Application Publication
(10) Pub. No.: US 2008/0034658 A1
(43) Pub. Date: Feb. 14, 2008

(54) Method and Apparatus for the Oxygen-Free Gasification of Hydrocarbonaceous and non-Hydrocarbonaceous Materials for the production of Synthesis gas

(76) Inventors: Catherine Ann Heiser, (US); Mark Lewis Heiser, (US)

Correspondence Address: Catrherine Ann Heiser;Mark Lewis Heiser, 106 Avenue B, Greenville, OH, 45331, US

(21) Appl. No.: 11/838,212

(22) Filed: Aug. 13, 2007

Related U.S. Application Data
(60) Provisional application No. 60/837,217, filed on Aug. 14, 2006.

(51) Int. Cl. C01B 3/00

(52) U.S. Cl. 48/77; 48/128; 48/67

(57) ABSTRACT

A method and device which enables an oxygen-free gasification process of both a hydrocarbon-containing (initiation/catalyzing) gas in combination either/both carbonaceous and non-carbonaceous solids and/or liquids or mixture thereof (feedstock material). This is a closed-loop system thus eliminating emissions and preventing environmentally damaging pollution. In one embodiment, a solid feedstock material is utilized, although solids, liquids or slurry may be used. Pulverized solid feedstock martial is first cleansed, dried and then saturated with a hydrocarbon containing gas to displace and remove any air or oxygen from voids in particulate matter. (Liquid feedstock material does not first need to be dried or saturated). The initiation gas is first injected into a high-temperature gasification tube. Simultaneously, gas saturated feedstock material is injected into a feedstock injection tube which openly terminates inside the gasification tube. Extreme heat within the tube (provided by internal electric elements) first begins to rapidly expand the initiating gas. As the initiating gas is reaching maximum expansion and velocity, the feedstock material, which is also heated and expanding, exits the feedstock injection tube and enters into the gasification tube. At this point two things happen simultaneously, heat causes the molecular structure of the initiating gas to dissociate while the feedstock material begins expansion and begins to collide with the dissociated mass from the initiating gas. The cracking of the hydrocarbon chains within the initiating gas causes the release of bond energy and generates great acceleration. The released bond energy, along with the addition of the external energy, rapidly expands the gas and causes the velocity of the moving mixture to rise sharply as it proceeds down the tube. Ultimately the molecular structure of the feedstock material is also dissociated or “cracked” releasing additional bond energy and causing additional heat and acceleration. This reaction produces a hydrogen rich synthesis gas which then exits the gasification tube where it may be further processed to remove certain amounts of hydrogen while still retaining the resultant synthesis gas. Additionally, free electrons are generated which may be converted to electricity through the use of an MHD generator. Resultant high temperature hydrogen as well as synthesis gas is cleansed by a filter and then cooled by liquid cooling jackets where heat is extracted by a circulating liquid. This heated circulating liquid may be directed into an external steam turbine for the further production of electricity. Resultant synthesis gas may be further utilized in external energy, petrochemical or manufacturing processes. Resultant Hydrogen gas may be further utilized for the production of electricity or chemical processes.

Since this system takes necessary steps to remove air, oxygen and moisture from feedstock materials as well as not utilizing steam, air, oxygen or combustion in the process, oxidized formations of carbon, sulfur and nitrogen are eliminated or severely restricted.

### RELATED APPLICATIONS

This application claims priority from U.S. Provisional Application Ser. No. 60/837,217, filed Aug. 14, 2006, entitled “Method and Apparatus for the Oxygen-Free Gasification of Hydrocarbonaceous and non-Hydrocarbonaceous Materials for the production of Synthesis gas”

### REFERENCES

| | | |
|---|---|---|
| 3956885 | May, 1976 | Davis, et al |
| 4322946 | April, 1982 | Murch, et al |
| 5950547 | September, 1999 | Wachendorfer. |
| 6216613 | April, 2001 | Wachendorfer. |
| 6827751 | December, 2004 | Kaufman, et al |

### BACKGROUND OF THE INVENTION

1. Field of the Invention

The present invention relates to methods and apparatus for the continuous gasification of hydrocarbonaceous and non-hydrocarbonaceous solids and liquids and combinations thereof into a resultant hydrogen rich gas synthesis gas and the production of electricity.

More particularly, the invention relates to a process in which a hydrocarbon gas and a hydrocarbonaceous or non-hydrocarbonaceous feedstock material are simultaneously heated to tremendous temperatures cracking molecular chains thereby producing a resultant hydrogen-rich synthesis gas for additional processes.

Additionally the device and process may be used to dissociate and reformulate various compounds such as but not limited to carbon dioxide and carbon monoxide into more environmentally acceptable resultant solids, liquids and gases.

2. Description of the Related Art

Existing dominant gasification technologies require the utilization of steam and\or oxygen to affect a result. Most existing technologies also utilize limited combustion. However, in doing so, these processes generate significant amounts of environmentally undesirable compounds such as oxidized carbon, sulfur and nitrogen compounds.

Existing technologies similar to this invention utilize an external heat source to generate heat within a tube. However, this method is not practical in that most heat generated external to the tube will remain unabsorbed by the tube due to its refractory properties. This means that even if temperatures within the tube due reach required temperatures for gasification, they are only temporary due to the volume of material flowing through the tube combined with the thermal conductivity of the tube being able to restore and maintain a constant temperature.

The current invention disclosed herein utilizes a heating apparatus internal to the high refractory gasification tube to attain temperatures necessary for a sustained and continuous gasification process.

Existing technologies similar to this invention which do not utilize air, steam or combustion to affect the resultant synthesis gas, do not remove air or oxygen from the feedstock materials prior to gasification. By not taking this step, the systems will produce a synthesis gas containing oxidized compounds of carbon, sulfur and nitrogen. The goal of those systems is to produce a hydrogen-rich synthesis gas in which the hydrogen may be removed while retaining a substantial amount of synthesis gas for further processes. However, since oxygen is present in the system, free molecules when cooled as stated in those inventions, will bond with the available oxygen molecules. Additionally, at least one invention states that partial combustion may be required to attain the necessary heat to affect the desired resultant synthesis gas thereby producing additional amounts of various environmentally undesirable forms of oxidized carbon, sulfur and nitrogen.

These technologies also utilize a cooling system to cool resultant gas immediately after gasification is achieved. By doing so, free hydrogen among other free elements will recombine with available molecules before any significant extraction of desirable materials is performed.

The current invention disclosed herein affects gasification of hydrocarbonaceous and non-hydrocarbonaceous materials purged of as much oxygen and air as possible prior to entry into the gasification step. Additionally, no oxygen is utilized during the process so as to prevent the production of oxidized compounds of carbon, sulfur and nitrogen.

The current invention disclosed herein does not immediately cool the resultant gasified material upon exit of the gasification tube so as to allow the extraction of free electrons and the separation of hydrogen immediately upon exiting the gasification tube.

### BRIEF SUMMARY OF THE INVENTION

The invention disclosed herein is a novel method and apparatus for the oxygen free gasification of various hydrocarbonaceous and non-hydrocarbonaceous feedstock materials. Feedstock materials may be solids, liquids or a slurry mixture of the two. The current invention is non-combustive and produces a resultant hydrogen rich synthesis gas available for further processing or utilization as fuel for energy processes.

In one preferred embodiment of the invention, solid coal feedstock material is first pulverized, cleaned and dried. Said pulverized coal is then saturated with a hydrocarbon gas to displace and remove any trapped air or oxygen within the coal dust. The gasification process begins as an initiating hydrocarbon gas is first injected into an internally heated gasification tube. Simultaneously the hydrocarbon gas saturated coal dust is injected into the feedstock injection tube which is contained in and openly terminates within the high-refractory gasification tube. Extreme heat within the gasification tube initially causes the violent expansion and acceleration of the initiating hydrocarbon gas. Simultaneously, the gas saturated coal dust is heated and the natural gas contained therein begins to expand and coal solids begin to soften as they pass through the feedstock injection tube. Extreme heat within the gasification tube causes the molecular chains of the hydrocarbon initiating gas to begin to break apart or “crack” and reach their maximum level of activation energy resulting in the release of heat and acceleration toward the discharge end of the gasification tube. As the cracked hydrocarbon gas reaches its maximum level of activation energy it reaches the discharge end of the feedstock injection tube (within the gasification tube). Here, the heated feedstock material mixture enters the gasification tube where the activation energy of the cracked initiating gas begins to collide with the softened coal particles and begins to break apart molecular chains within the coal particles. As the molecular chains within the coal break, a substantial amount of energy contained within the molecular bonds is released resulting in further heat and acceleration and the return of molecules to their constituent elements. This series of reactions within the gasification tube ultimately produces a hydrogen rich synthesis gas.

If so desired, the resultant hydrogen rich synthesis gas may, upon exiting the gasification tube, pass through a magnetohydrodynamic (MHD) generator which converts free electrons into electricity. Said MHD generator discharges captured electricity through external electrical connections for use further upstream in this invention or for distribution through existing power grids.

Resultant gas proceeds next into a particulate material separator to remove inert or un-reacted materials from the feedstock material.

Cleaned resultant gas may if desired pass through a hydrogen separation apparatus to remove desired amounts of hydrogen. Removed hydrogen gas is then cooled using a liquid cooling apparatus. Heat captured by the liquid cooling apparatus is then transferred to an external steam turbine for the further generation of electricity which may also be used in internal processes further upstream in this invention or distributed through existing power grids. Captured hydrogen is compressed and stored for further use in external processes.

Resultant gas continues next to proceed through a liquid cooling apparatus where said resultant gas is cooled and heat extracted. Heat captured by the liquid cooling apparatus is then transferred to an external steam turbine for the further generation of electricity which may also be used in internal processes further upstream in this invention or distributed through existing power grids.

Resultant synthesis gas then enters a gas evacuation apparatus that removes synthesis gas from the system by use of at least one pump. This pump then transfers the synthesis gas to a compressor where the gas is compressed and transferred to at least one pressurized storage tank. The resultant synthesis gas may now be used for further power generating apparatuses or for use in petrochemical or other processes.

### BRIEF DESCRIPTION OF THE DRAWINGS

FIG. 1 is a system diagram illustrating the preferred embodiment of solid or liquid material gasifying apparatus according to the present invention

FIG. 2 is a profile view of gasification tube assembly with insulating housing

FIG. 3 is a reference view of gasification tube assembly with insulating housing

FIG. 4 is a profile view of gasification tube assembly and components

FIG. 5 is a reference view of gasification tube assembly and components

FIG. 6 is an exploded profile view of gasification tube assembly and components

FIG. 7 is an exploded reference view of gasification tube assembly and components

FIG. 8 is a profile view of the main internal heating assembly and components

FIG. 9 is a reference view of the main internal heating assembly and components

FIG. 10 is an exploded profile view of the main internal heating assembly and components

FIG. 11 is an exploded reference view of the main internal heating assembly and components

FIG. 12 is a profile view of the injector apparatus and components

FIG. 13 is a reference view of the injector apparatus and components

FIG. 14 is an exploded profile view of the injector apparatus and components

FIG. 15 is an exploded reference view of the injector apparatus and components

FIG. 16 is a profile view of the condensing nozzle

FIG. 17 is a reference view of the condensing nozzle

### REFERENCE NUMBERS IN DRAWINGS

10 Primary Feedstock Hopper

11 Grinder/Shredder

12 Cleaner

13 Drier

14 Saturation Tank Hopper

15 Saturation Tank

16 Gas Supply

17 Gasification Assembly

18 MHD Generator

19 Particulate Separator

20 Particulate Accumulator

21 Hydrogen Separator

22 Resultant Gas Liquid Cooling Jacket

23 Resultant Gas Evacuation Pump

24 Resultant Gas Compressor

25 Resultant Gas Storage Tank

26 Hydrogen Liquid Cooling Jacket

27 Hydrogen Evacuation Pump

28 Hydrogen Compressor

29 Hydrogen Storage Tank

30 Steam Turbine

31 Gasification Tube Assembly

32 Injector Assembly

33 Condensing Nozzle Assembly

34 Discharge End of Gasification Tube

35 Insulating Housing Insulator Layer

36 Insulating Housing Outer Shell

37 Gasification Tube

38 Main Internal Heating Assembly

39 Main Internal Heating Element Support

40 Main Internal Heating Element

41 Main Internal Heating Assembly Support

42 Gasification Tube Mounting Flange

43 Feedstock Injection Tube

44 Feedstock Injection Tube Heating Element

45 Initiating Gas Injector

46 Injector Assembly Mounting Flange

47 Condensing Nozzle Mounting Flange

48 Condensing Nozzle Internal Reduction Member

50 Insulating Housing

51 Heating Element Insulators

### DETAILED DESCRIPTION OF THE INVENTION

Explained herein below is one preferred embodiment of the invention and referenced by the accompanying drawings. However, the reader should keep in mind that the invention is not limited to this example as it may gasify solids as well as liquids and slurries to produce electricity, hydrogen, synthesis gas, petroleum products or any combination thereof. In this example, a coal solid feedstock is converted to produce electricity, hydrogen and synthesis gas.

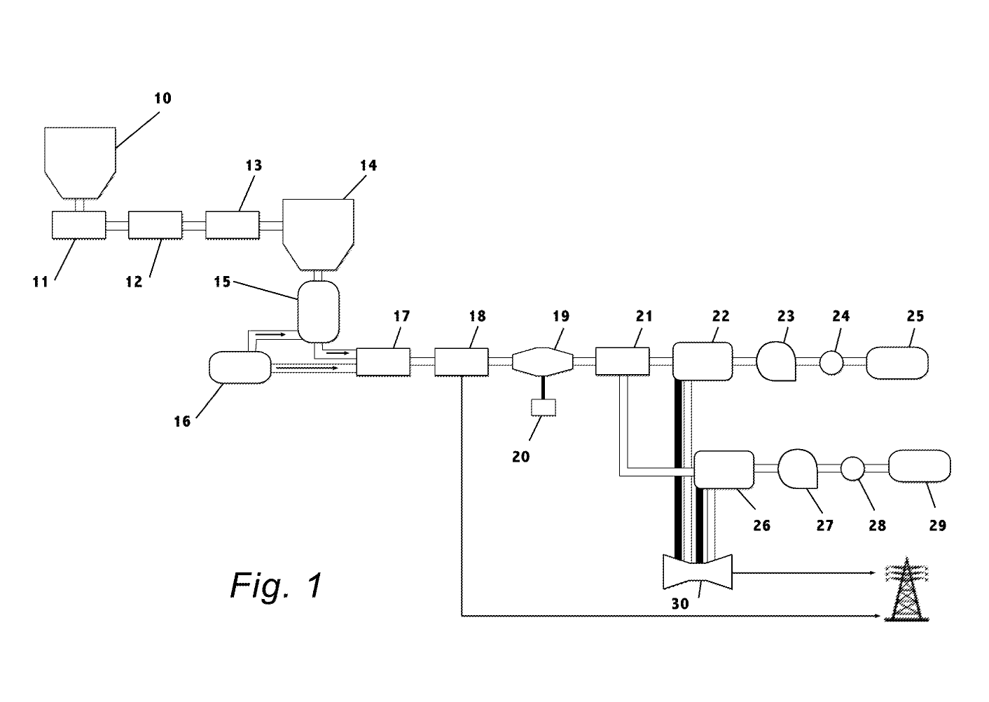

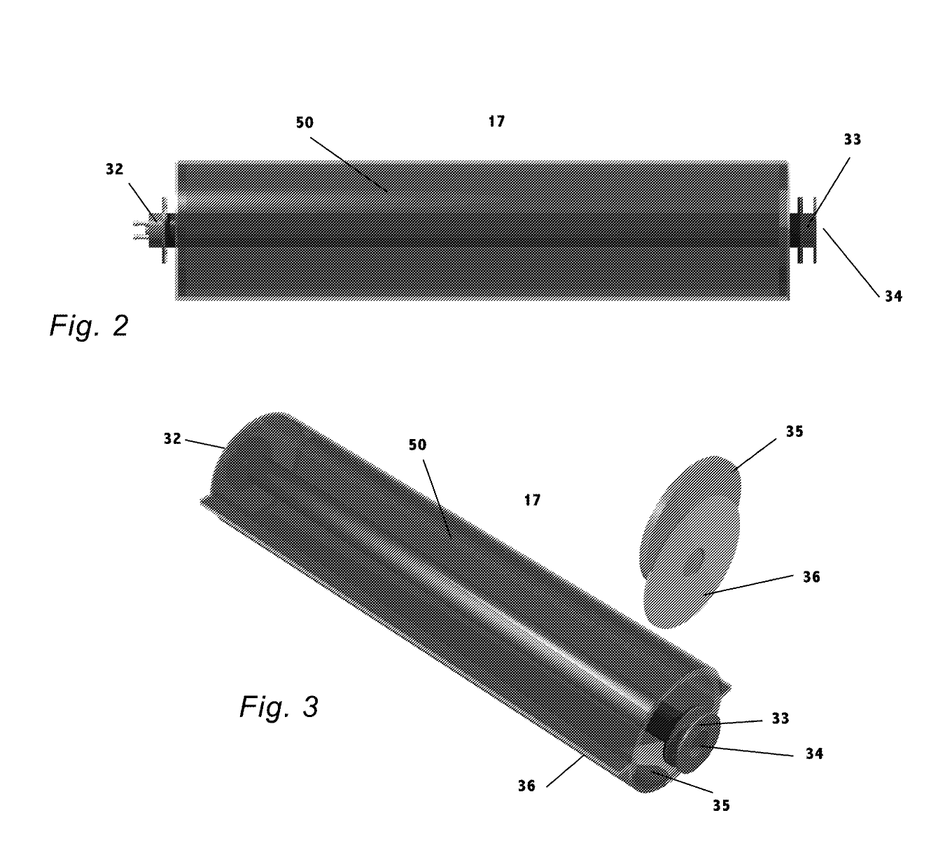

FIG. 1 outlines the entire gasification system in accordance with this example.

First, raw coal is fed from primary feedstock hopper 10 and pulverized to at least 60 screen mesh in grinder/shredder 11. From there, the pulverized coal is fed into a material cleaner 12 where most contaminants (i.e. metals and rock) are removed. The coal powder is then fed into a drier system 13 to remove entrained moisture resulting in a dried feedstock material. The dried feedstock material is then loaded into saturation tank hopper 14 after which it pass into a saturation tank 15 wherein it is mixed with an injected hydrocarbon containing gas from gas supply 16 to displace and remove any entrained air and/or oxygen from the feedstock material.

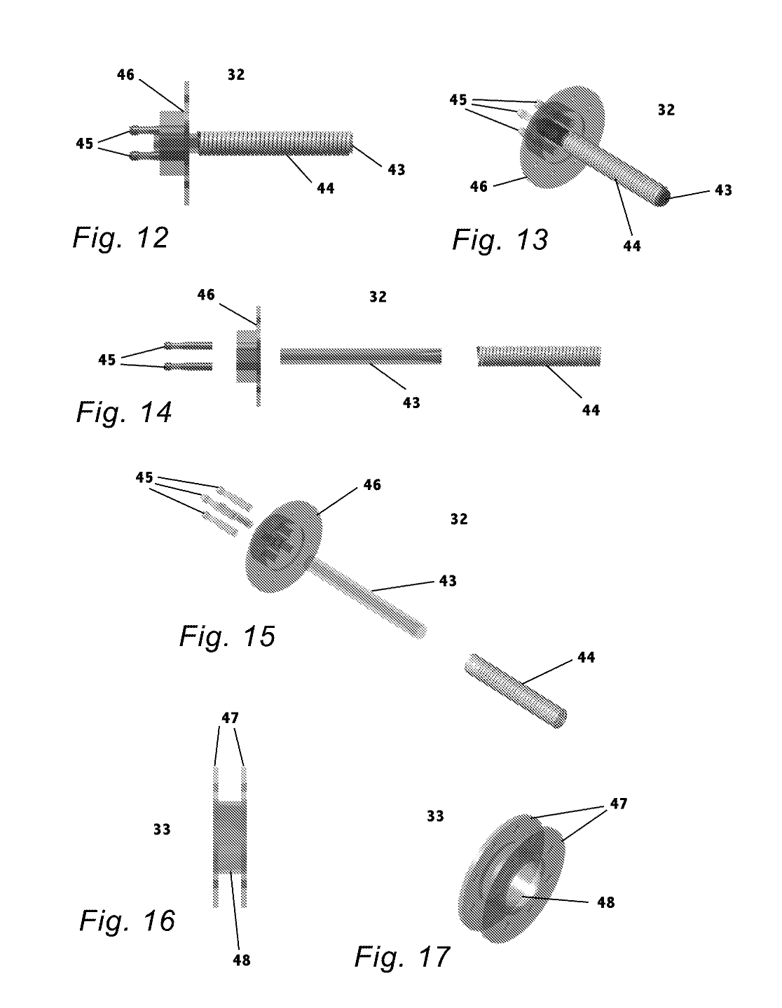

FIGS. 12, 13, 14 & 15 illustrate the injector apparatuses where the gasification stage begins with the gas supply lines delivering a pressurized hydrocarbon gas from gas supply 16. In this example natural gas is supplied to the intake side of the initiating gas injector assembly 32. In addition, at this stage a feedstock material supply line delivers the pressurized natural gas saturated coal powder from the saturation tank 15 to the intake side of the feedstock injection tube 43. Said feedstock injection tube 43 protrudes into the interior of the gasification tube 37. Injector assembly 32 simultaneously delivers pressurized initiation gas and pressurized gas saturated feedstock material into the intake end of the heated gasification tube 37. Feedstock injector tube protrusion into gasification tube is present to aid in the reaction process however, it may not be required.

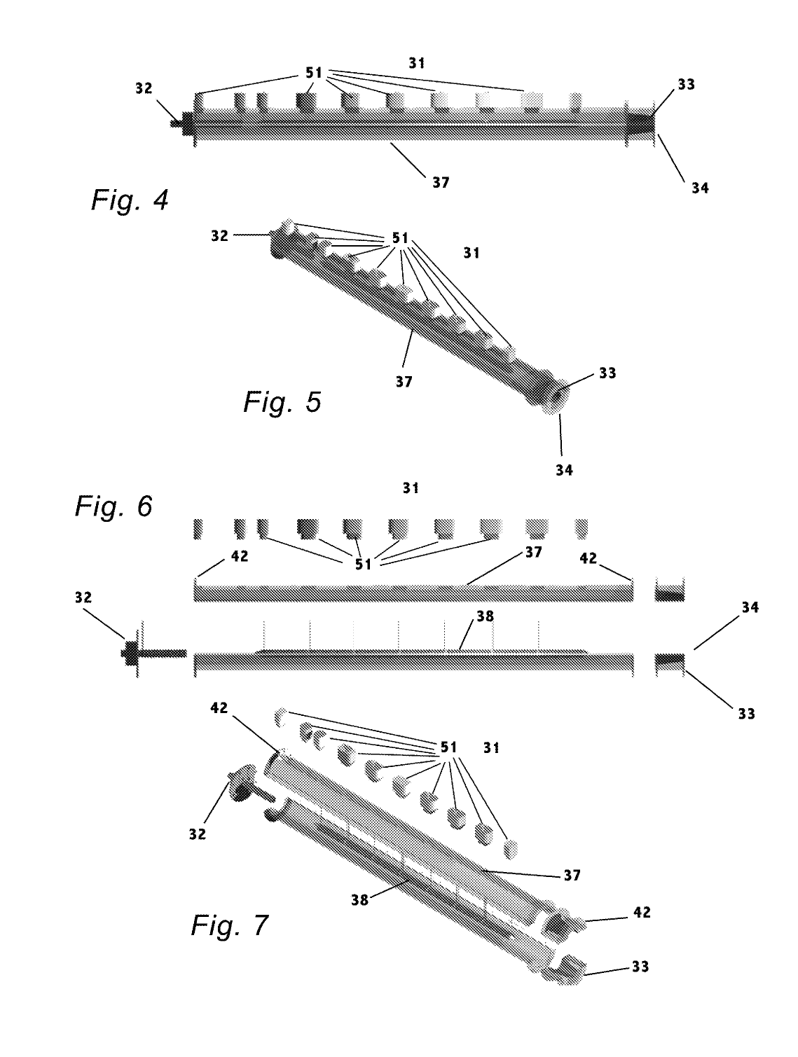

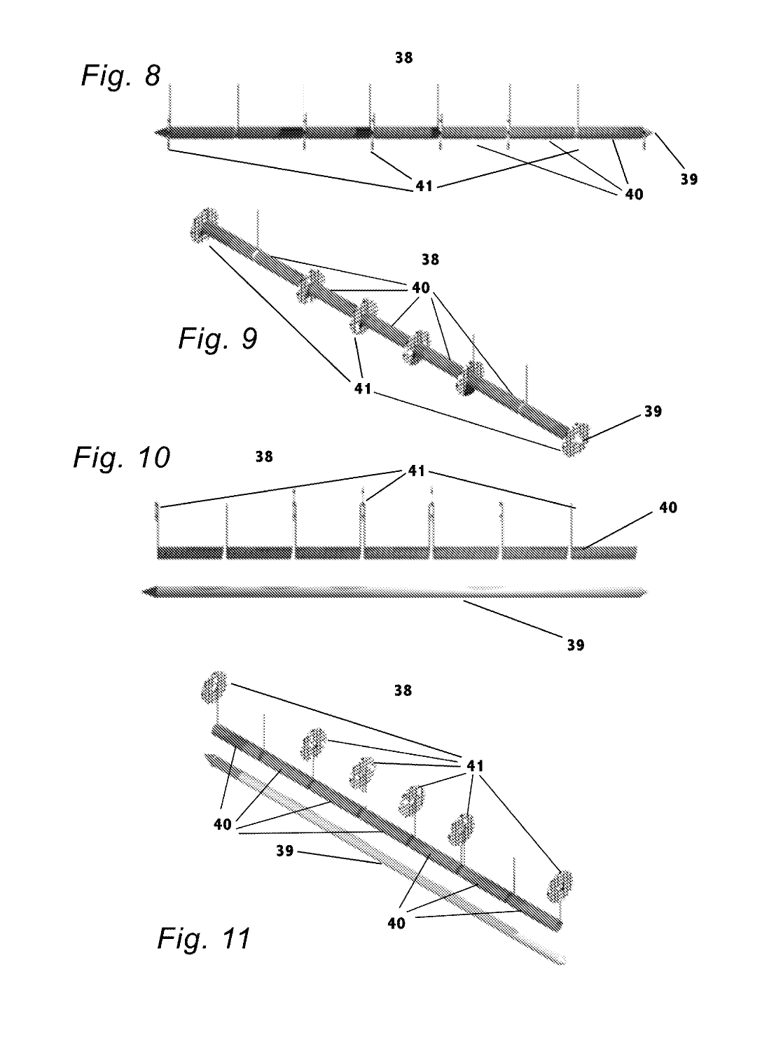

FIGS. 4, 5, 6 and 7 illustrate the gasification tube assembly and components 31. In this example the gasification tube 37 is made of a high refractory material. Contained within the gasification tube are the exit end of the feedstock injection tube 43 and the internal heating element(s). In this example, said internal heating element(s) are comprised of 6 separate heating coils 40, 44 (although as few as one heating element may be utilized). FIGS. 12, 13, 14 and 15 illustrate the feedstock injector tube 43 and its components. The portion of feedstock injector tube 43 that is contained within the gasification tube 37 is externally heated by the feedstock injector tube element 44 which is coiled around said portion of feedstock injector tube 43. Said feedstock injector tube element 44 partially heats both the interior of the gasification tube 37 as well as the interior of the feedstock injector tube 43. FIGS. 8, 9, 10 and 11 illustrate the main internal heating assembly 38 and its components. Also contained within the gasification tube 37 are the main internal heating elements 40. Said main internal heating elements 40 coil around main internal heating element support 39. In this example, said main internal heating elements 40 and main internal heating element support 39 are maintained within the tube by main internal heating assembly support 41 which in this case are made of ceramic, although other support methods may be employed. The majority of the gasification tube 37 is contained within the insulating housing 50. Temperatures within the refractory gasification tube 37 are maintained between 1,100 and 2,200 degrees Celsius. (This temperature will vary depending on the feedstock material to be gasified.) Attached to the exit end of said gasification tube 37 is a condensing nozzle 33. Said condensing nozzle 33 is serves to minimally condense and focus resultant gas generated within gasification tube 37.

Pressurized natural gas is injected into the electrically internally heated high refractory tube 37 through the initiating gas injectors 45. Simultaneously, the pressurized hydrocarbon gas saturated coal powder is injected into the feedstock injector tube 43. Tremendous heat generated by the internal heating elements 40, 44 heats and begins to expand the initiating gas. Said heat simultaneously expands gas contained within the saturated coal powder feedstock mixture as well as softens the coal powder as it proceeds through the feedstock injector tube 43. The high temperature heat within the gasification tube 37 affects the molecular excitation and violent expansion of the initiating gas allowing it to reach its maximum activation energy and resulting in the cracking of the natural gas's molecular structure. This violent expansion forces the rapidly expanding gas toward the discharge end 34 of the gasification tube 37. As the gas reaches its maximum activation energy, the molecularly dissociated initiation gas's kinetic energy begins to collide with the heated and softened coal solids as the mixture proceeds towards the discharge end 34 of said gasification tube 37. This kinetic energy of the cracked natural gas ultimately breaks apart or cracks the molecular structure of the coal solids returning the said coal solids to their constituent elements. The combination of cracked natural gas combined with the cracked coal solids produces a resultant hydrogen rich synthesis gas.

FIGS. 16 and 17 illustrate the condensing nozzle 33 and its components. Said resultant hydrogen rich synthesis gas proceeds through condensing nozzle 33 as it exits the discharge end of gasification tube 37. Said condensing nozzle 33 utilizes condensing nozzle internal reduction member 48 to mildly compress and focus said resultant synthesis gas upon exiting gasification tube 37.

Said resultant gas then passes through a particulate separator 19 such as a cyclonic particulate separator wherein inert solids and any un-reacted feedstock materials are separated and removed from the resultant gas and discharged into at least one particulate accumulator 20.

If so desired, as the resultant gas exits the particulate separator 19, it enters a hydrogen separator unit 21. Said hydrogen separator 21 unit removes hydrogen from hydrogen rich resultant gas. An evacuation pump 27 is used to remove extracted hydrogen gas and a liquid cooling jacket 26 cools hydrogen removed from said resultant gas. Upon cooling of the extracted hydrogen gas, the gas is compressed by at least one compressor 28 and stored in hydrogen storage tank 29 for future use in additional energy utilization capacities. Said energy utilization capacities may include, but are not limited to hydrogen-fueled turbines or hydrogen-powered fuel cells.

If so desired, as the resultant gas exits the gasification assembly 17, it enters and passes through a magnetohydrodynamic (MHD) generator 18. Said MHD generator 18 has nonconductive tube wall material in which is an array of electrically charged contacts. As the resultant gas passes through the walls of the MHD generator 18 a charge is induced in the field, which is drawn off as electrical power. The electricity generated through the MHD generator 18 is discharged through electrodes on the outside of the MHD generator.

As the remaining hydrogen depleted resultant gas exits the hydrogen separator 21, it proceeds to the intake end of the liquid cooling jacket 22. Said liquid cooling jacket 22 circulates a liquid coolant such as water to extract heat from and reduce the temperature of the entering high temperature resultant gas. Heat captured by the liquid within the liquid cooling jacket 22 is further utilized in an external steam turbine 30 for the generation of electricity.

Upon exiting the liquid cooling jacket 22, said cooled resultant gas enters a gas evacuation pump 23. Said gas evacuation pump 23 removes the resultant gas from the system. Said resultant gas removed from system by gas evacuation pump 23 is transferred to at least one compressor 24 which compresses said gas and transfers compressed gas to storage tanks 25 for later use or further processing.

1. A method and apparatus for transforming crushed hydrocarbonaceous solids into a resultant hydrogen rich synthesis gas therefrom comprising:
1. Pulverizing hydrocarbonaceous solids;
2. Cleansing of hydrocarbonaceous solids for the removal of impurities;
3. Drier for the removal of moisture in crushed and cleansed solids;
4. Pre-saturating cleansed crushed hydrocarbonaceous solids with a hydrocarbon gas;
5. Gas supply, supplying hydrocarbon gas
6. Injector apparatus to introduce said hydrocarbonaceous gas into gasification tube;
(a) Said injector apparatus having an intake end and a discharge end
(b) Said injector apparatus having at least one intake port on said intake end and at least one discharge port on said discharge end for the injection of said hydrocarbonaceous gas
7. Feedstock injector apparatus to introduce a mixture of said hydrocarbonaceous gas saturated solids feedstock material into gasification tube;
(a) Said injector apparatus having an intake end and a discharge end
(b) Said injector apparatus having an intake port on said intake end and a discharge port on said discharge end for the injection of said hydrocarbonaceous gas saturated feedstock material
(c) Said discharge port further comprises an expansion nozzle.
(d) Said discharge port encompasses a dispersal nozzle to aid in atomization of said gas saturated feedstock material as it is introduced into the gasification tube.
8. A high refractory material gasification tube comprising;
(a) A tube having one intake end and one discharge end wherein said intake end is connected to discharge end of said injector apparatus
(b) A reducing nozzle connected to discharge end of said gasification tube
(c) Heat sources heating said gasification tube, thereby heating said hydrocarbonaceous mixture to produce a resultant hydrogen-rich synthesis gas.

2. An apparatus according to claim 1, wherein said heat sources comprise at least one internal heating element.
1. One said heating element may be fitted around outside of portion of said feedstock injector apparatus wherein said feedstock injector apparatus protrudes into interior of said gasification tube.
2. Second said heating element(s) is internal to the gasification tube and is fitted around an internal support rod.
(a) Said internal support rod is made of a low thermally conductive refractory material.
(b) Said internal support rod runs a portion of the length of the interior of the gasification tube.
b 3. Said second heating element(s) and said support rod are supported by at least one interior support apparatus.

3. An apparatus according to claim 1, additionally comprising a particulate filter/separator to remove solid particulate matter from resultant hydrogen rich synthesis gas, connected to the discharge end of said gasification tube.
1. Said particulate filter/separator comprises at least one intake end and one discharge end for resultant gas
2. Said particulate filter/separator further comprises an additional discharge port for the removal of filtered solids
3. Said particulate filter/separator further comprises a solids accumulator

4. An apparatus according to claim 1, additionally comprising a liquid cooling jacket for the cooling of resultant hydrogen rich synthesis gas, connected to the discharge end of said particulate filter/separator.
1. Said liquid cooling jacket comprises one intake end and one discharge end for resultant gas
2. Said liquid cooling jacket further comprises at least one intake port and at least one discharge port for circulating liquid
3. Said liquid cooling jacket comprises a circulating cooling liquid

5. An apparatus according to claim 1, additionally comprising a gas evacuation apparatus for the removal of resultant hydrogen rich synthesis gas, connected to the gas discharge end of said liquid cooling jacket
1. Said gas evacuation apparatus removes resultant hydrogen rich synthesis gas from the system to maintain flow and prevent backpressure in the system and allow for further storage of resultant gas
2. Said gas evacuation apparatus comprises one intake end and one discharge end

6. An apparatus according to claim 5, wherein said gas evacuation apparatus is a pump

7. An apparatus according to claim 1, additionally comprising a compressor connected to the discharge end of gas evacuation apparatus
1. Said compressor comprises one intake end and one discharge end
2. Discharge end of said compressor connects to at least one compressed gas storage tank

8. A method and apparatus for transforming crushed non-hydrocarbonaceous solids into a hydrogen rich synthesis gas therefrom comprising:
1. Pulverizing non-hydrocarbonaceous solids;
2. Cleansing of non-hydrocarbonaceous solids for the removal of impurities;
3. Drier for the removal of moisture in crushed and cleansed solids;
4. Pre-saturating cleansed crushed non-hydrocarbonaceous solids with a hydrocarbon gas;
5. Gas supply, supplying hydrocarbonaceous gas
6. Injector apparatus to introduce said hydrocarbonaceous gas into gasification tube;
(a) Said injector apparatus having an intake end and a discharge end
(b) Said injector apparatus having at least one intake port on said intake end and at least one discharge port on said discharge end for the injection of said hydrocarbonaceous gas
7. Feedstock injector apparatus to introduce a mixture of said hydrocarbonaceous gas saturated non-hydrocarbonaceous solids feedstock material into gasification tube;
(a) Said injector apparatus having an intake end and a discharge end
(b) Said injector apparatus having an intake port on said intake end and a discharge port on said discharge end for the injection of said hydrocarbonaceous gas saturated non-hydrocarbonaceous solids feedstock material
(c) Said discharge port further comprises an expansion nozzle.
(d) Said discharge port encompasses a dispersal nozzle to aid in atomization of said gas saturated feedstock material as it is introduced into the gasification tube.
8. A high refractory material gasification tube comprising;
(d) A tube having one intake end and one discharge end wherein said intake end is connected to discharge end of said injector apparatus
(e) A reducing nozzle connected to discharge end of said gasification tube
(f) Heat sources heating said gasification tube, thereby heating said hydrocarbonaceous mixture to produce a resultant hydrogen-rich synthesis gas.

9. An apparatus according to claim 8, wherein said heat sources comprise at least one internal heating element.
1. One said heating element may be fitted around outside of portion of said feedstock injector apparatus wherein said feedstock injector apparatus protrudes into interior of said gasification tube.
2. Second said heating element(s) is internal to the gasification tube and is fitted around an internal support rod.
(a) Said internal support rod is made of a low thermally conductive refractory material.
(b) Said internal support rod runs a portion of the length of the interior of the gasification tube.
3. Said second heating element(s) and said support rod are supported by at least one interior support apparatus.

10. An apparatus according to claim 8, additionally comprising a particulate filter/separator to remove solid particulate matter from resultant hydrogen rich synthesis gas, connected to the discharge end of said gasification tube.
1. Said particulate filter/separator comprises at least one intake end and one discharge end for resultant gas
2. Said particulate filter/separator further comprises an additional discharge port for the removal of filtered solids
3. Said particulate filter/separator further comprises a solids accumulator

11. An apparatus according to claim 8, additionally comprising a liquid cooling jacket for the cooling of resultant hydrogen rich synthesis gas, connected to the discharge end of said particulate filter/separator.
1. Said liquid cooling jacket comprises one intake end and one discharge end for resultant gas
2. Said liquid cooling jacket further comprises at least one intake port and at least one discharge port for circulating liquid
3. Said liquid cooling jacket comprises a circulating cooling liquid

12. An apparatus according to claim 8, additionally comprising a gas evacuation apparatus for the removal of resultant hydrogen rich synthesis gas, connected to the gas discharge end of said liquid cooling jacket
1. Said gas evacuation apparatus removes resultant hydrogen rich synthesis gas from the system to maintain flow and prevent backpressure in the system and allow for further storage of resultant gas
2. Said gas evacuation apparatus comprises one intake end and one discharge end

13. An apparatus according to claim 12, wherein said gas evacuation apparatus is a pump

14. An apparatus according to claim 8, additionally comprising a compressor connected to the discharge end of gas evacuation apparatus
1. Said compressor comprises one intake end and one discharge end
2. Discharge end of said compressor connects to at least one compressed gas storage tank

15. A method and apparatus for transforming hydrocarbonaceous liquids into a hydrogen rich synthesis gas therefrom comprising:
1. Cleansing of hydrocarbonaceous liquids for the removal of impurities;
2. Gas supply, supplying hydrocarbon gas
3. Injector apparatus to introduce said hydrocarbonaceous gas into gasification tube;
(a) Said injector apparatus having an intake end and a discharge end
(b) Said injector apparatus having at least one intake port on said intake end and at least one discharge port on said discharge end for the injection of said hydrocarbonaceous gas
4. Feedstock injector apparatus to introduce said hydrocarbonaceous liquid feedstock material into gasification tube;
(a) Said injector apparatus having an intake end and a discharge end
(b) Said injector apparatus having an intake port on said intake end and a discharge port on said discharge end for the injection of said hydrocarbonaceous liquid
(c) Said discharge port further comprises an expansion nozzle.
(d) Said discharge port encompasses a dispersal nozzle to aid in atomization of said hydrocarbonaceous liquid feedstock material as it is introduced into the gasification tube.
5. A high refractory material gasification tube comprising;
(a) A tube having one intake end and one discharge end wherein said intake end is connected to discharge end of said injector apparatus
(b) A reducing nozzle connected to discharge end of said gasification tube
(c) Heat sources heating said gasification tube, thereby heating said hydrocarbonaceous mixture to produce a resultant hydrogen-rich synthesis gas.

16. An apparatus according to claim 15, wherein said heat sources comprise at least one internal heating element.
1. One said heating element may be fitted around outside of portion of said feedstock injector apparatus wherein said feedstock injector apparatus protrudes into interior of said gasification tube.
2. Second said heating element(s) is internal to the gasification tube and is fitted around an internal support rod.
(a) Said internal support rod is made of a low thermally conductive refractory material.
(b) Said internal support rod runs a portion of the length of the interior of the gasification tube.
3. Said second heating element(s) and said support rod are supported by at least one interior support apparatus.

17. An apparatus according to claim 15, additionally comprising a particulate filter/separator to remove solid particulate matter from resultant hydrogen rich synthesis gas, connected to the discharge end of said gasification tube.
1. Said particulate filter/separator comprises at least one intake end and one discharge end for resultant gas
2. Said particulate filter/separator further comprises an additional discharge port for the removal of filtered solids
3. Said particulate filter/separator further comprises a solids accumulator

18. An apparatus according to claim 15, additionally comprising a liquid cooling jacket for the cooling of resultant hydrogen rich synthesis gas, connected to the discharge end of said particulate filter/separator.
1. Said liquid cooling jacket comprises one intake end and one discharge end for resultant gas
2. Said liquid cooling jacket further comprises at least one intake port and at least one discharge port for circulating liquid
3. Said liquid cooling jacket comprises a circulating cooling liquid

19. An apparatus according to claim 15, additionally comprising a gas evacuation apparatus for the removal of resultant hydrogen rich synthesis gas, connected to the gas discharge end of said liquid cooling jacket
1. Said gas evacuation apparatus removes resultant hydrogen rich synthesis gas from the system to maintain flow and prevent backpressure in the system and allow for further storage of resultant gas
2. Said gas evacuation apparatus comprises one intake end and one discharge end

20. An apparatus according to claim 19, wherein said gas evacuation apparatus is a pump

21. An apparatus according to claim 15, additionally comprising a compressor connected to the discharge end of gas evacuation apparatus
1. Said compressor comprises one intake end and one discharge end
2. Discharge end of said compressor connects to at least one compressed gas storage tank

22. A method and apparatus for transforming non-hydrocarbonaceous liquids into a hydrogen rich synthesis gas therefrom comprising:
1. Cleansing of non-hydrocarbonaceous liquids for the removal of impurities;
2. Gas supply, supplying hydrocarbon gas
3. Injector apparatus to introduce a hydrocarbonaceous gas into gasification tube;
(a) Said injector apparatus having an intake end and an discharge end
(b) Said injector apparatus having at least one intake port on said intake end and at least one discharge port on said discharge end for the injection of said hydrocarbonaceous gas
4. Feedstock injector apparatus to introduce a non-hydrocarbonaceous liquid feedstock material into gasification tube;
(a) Said injector apparatus having an intake end and a discharge end
(b) Said injector apparatus having an intake port on said intake end and a discharge port on said discharge end for the injection of said non-hydrocarbonaceous liquid
(c) Said discharge port further comprises an expansion nozzle.
(d) Said discharge port encompasses a dispersal nozzle to aid in atomization of said non-hydrocarbonaceous liquid feedstock material as it is introduced into the gasification tube.
5. A high refractory material gasification tube comprising;
(a) A tube having one intake end and one discharge end wherein said intake end is connected to discharge end of said injector apparatus
(b) A reducing nozzle connected to discharge end of said gasification tube
(c) Heat sources heating said gasification tube, thereby heating said hydrocarbonaceous mixture to produce a resultant hydrogen-rich synthesis gas.

23. An apparatus according to claim 22, wherein said heat sources comprise at least one internal heating element.
1. One said heating element may be fitted around outside of portion of said feedstock injector apparatus wherein said feedstock injector apparatus protrudes into interior of said gasification tube.
2. Second said heating element(s) is internal to the gasification tube and is fitted around an internal support rod.
(a) Said internal support rod is made of a low thermally conductive refractory material.
(b) Said internal support rod runs a portion of the length of the interior of the gasification tube.
3. Said second heating element(s) and said support rod are supported by at least one interior support apparatus.

24. An apparatus according to claim 22, additionally comprising a particulate filter/separator to remove solid particulate matter from resultant hydrogen rich synthesis gas, connected to the discharge end of said gasification tube.
1. Said particulate filter/separator comprises at least one intake end and one discharge end for resultant gas
2. Said particulate filter/separator further comprises an additional discharge port for the removal of filtered solids
3. Said particulate filter/separator further comprises a solids accumulator

25. An apparatus according to claim 22, additionally comprising a liquid cooling jacket for the cooling of resultant hydrogen rich synthesis gas, connected to the discharge end of said particulate filter/separator.
1. Said liquid cooling jacket comprises one intake end and one discharge end for resultant gas
2. Said liquid cooling jacket further comprises at least one intake port and at least one discharge port for circulating liquid
3. Said liquid cooling jacket comprises a circulating cooling liquid

26. An apparatus according to claim 22, additionally comprising a gas evacuation apparatus for the removal of resultant hydrogen rich synthesis gas, connected to the gas discharge end of said liquid cooling jacket
1. Said gas evacuation apparatus removes resultant hydrogen rich synthesis gas from the system to maintain flow and prevent backpressure in the system and allow for further storage of resultant gas
2. Said gas evacuation apparatus comprises one intake end and one discharge end

27. An apparatus according to claim 26, wherein said gas evacuation apparatus is a pump

28. An apparatus according to claim 22, additionally comprising a compressor connected to the discharge end of gas evacuation apparatus
1. Said compressor comprises one intake end and one discharge end
2. Discharge end of said compressor connects to at least one compressed gas storage tank

29. A method and apparatus for transforming slurry mixture of hydrocarbonaceous and non-hydrocarbonaceous materials, solids and/or liquids into a hydrogen rich synthesis gas therefrom comprising:
1. Cleansing of said slurry mixture for the removal of impurities;
2. Gas supply, supplying hydrocarbon gas
3. Injector apparatus to introduce a hydrocarbonaceous gas into gasification tube;
(a) Said injector apparatus having an intake end and a discharge end
(b) Said injector apparatus having at least one intake port on said intake end and at least one discharge port on said discharge end for the injection of said hydrocarbonaceous gas
4. Feedstock injector apparatus to introduce said slurry mixture feedstock material into gasification tube;
(a) Said injector apparatus having an intake end and a discharge end
(b) Said injector apparatus having an intake port on said intake end and a discharge port on said discharge end for the injection of said slurry mixture
(c) Said discharge port further comprises an expansion nozzle.
(d) Said discharge port encompasses a dispersal nozzle to aid in atomization of said slurry mixture feedstock material as it is introduced into the gasification tube.
5. A high refractory material gasification tube comprising;
(a) A tube having one intake end and one discharge end wherein said intake end is connected to discharge end of said injector apparatus
(b) A reducing nozzle connected to discharge end of said gasification tube
(c) Heat sources heating said gasification tube, thereby heating said slurry mixture to produce a resultant hydrogen-rich synthesis gas.

30. An apparatus according to claim 29, wherein said heat sources comprise at least one internal heating element.
1. One said heating element may be fitted around outside of portion of said feedstock injector apparatus wherein said feedstock injector apparatus protrudes into interior of said gasification tube.
2. Second said heating element(s) is internal to the gasification tube and is fitted around an internal support rod.
(a) Said internal support rod is made of a low thermally conductive refractory material.
(b) Said internal support rod runs a portion of the length of the interior of the gasification tube.
3. Said second heating element(s) and said support rod are supported by at least one interior support apparatus.

31. An apparatus according to claim 29, additionally comprising a particulate filter/separator to remove solid particulate matter from resultant hydrogen rich synthesis gas, connected to the discharge end of said gasification tube.
1. Said particulate filter/separator comprises at least one intake end and one discharge end for resultant gas
2. Said particulate filter/separator further comprises an additional discharge port for the removal of filtered solids
3. Said particulate filter/separator further comprises a solids accumulator

32. An apparatus according to claim 29, additionally comprising a liquid cooling jacket for the cooling of resultant hydrogen rich synthesis gas, connected to the discharge end of said particulate filter/separator.
1. Said liquid cooling jacket comprises one intake end and one discharge end for resultant gas
2. Said liquid cooling jacket further comprises at least one intake port and at least one discharge port for circulating liquid
3. Said liquid cooling jacket comprises a circulating cooling liquid

33. An apparatus according to claim 29, additionally comprising a gas evacuation apparatus for the removal of resultant hydrogen rich synthesis gas, connected to the gas discharge end of said liquid cooling jacket
1. Said gas evacuation apparatus removes resultant hydrogen rich synthesis gas from the system to maintain flow and prevent backpressure in the system and allow for further storage of resultant gas
2. Said gas evacuation apparatus comprises one intake end and one discharge end

34. An apparatus according to claim 33, wherein said gas evacuation apparatus is a pump

35. An apparatus according to claim 29, additionally comprising a compressor connected to the discharge end of gas evacuation apparatus
1. Said compressor comprises one intake end and one discharge end Discharge end of said compressor connects to at least one compressed gas storage tank
